(19) United States
(12) Patent Application Publication
(10) Pub. No.: US 2024/0184103 A1
(43) Pub. Date: Jun. 6, 2024

(54) LIGHT CORRECTION COEFFICIENT PREDICTION METHOD, LIGHT CORRECTION COEFFICIENT PREDICTION DEVICE, MACHINE LEARNING METHOD, PRE-PROCESSING METHOD IN MACHINE LEARNING, AND TRAINED LEARNING MODEL

(71) Applicant: HAMAMATSU PHOTONICS K.K., Hamamatsu-shi, Shizuoka (JP)

(72) Inventors: Masashi FUKUHARA, Hamamatsu-shi, Shizuoka (JP); Yu HASHIMOTO, Hamamatsu-shi, Shizuoka (JP); Kazuya SUZUKI, Hamamatsu-shi, Shizuoka (JP); Tomoko HYODO, Hamamatsu-shi, Shizuoka (JP)

(73) Assignee: HAMAMATSU PHOTONICS K.K., Hamamatsu-shi, Shizuoka (JP)

(21) Appl. No.: 18/285,967

(22) PCT Filed: Jan. 13, 2022
(86) PCT No.: PCT/JP2022/000967

§ 371 Date: Oct. 6, 2023

(30) Foreign Application Priority Data
Apr. 15, 2021 (JP) 2021-069073

(51) Int. Cl. G02B 27/00; G06N 20/00

(52) U.S. Cl. CPC G02B 27/0012; G02B 27/0025; G06N 20/00

(57) ABSTRACT

A control device includes: an acquisition unit that acquires, for an intensity image obtained by observing an action caused by light corrected using a spatial light modulator based on a Zernike coefficient, an intensity distribution that is a distribution of intensities in a plurality of regions of interest within a predetermined range on the intensity image; a generation unit that calculates a comparison result between the intensity distribution and a target distribution to generate comparison data; and a prediction unit that predicts a Zernike coefficient, which is for performing aberration correction related to the light so that the intensity distribution approaches the target distribution, by inputting the comparison data and the Zernike coefficient, which is a basis of the intensity distribution, to a learning model.

### TECHNICAL FIELD

One aspect of embodiments relates to a light correction coefficient prediction method, a light correction coefficient prediction device, a machine learning method, a pre-processing method in machine learning, and a trained learning model.

### BACKGROUND ART

Conventionally, techniques for correcting aberrations caused by an optical system, such as an objective lens, are known. For example, in order to correct aberrations present in the objective lens, Patent Literature 1 below describes a technique for changing a Zernike coefficient to give a wavefront shape for setting a phase pattern, which is to be applied to a wavefront modulation element, to a coefficient that minimizes the spot diameter of laser light in a virtual image. In addition, Patent Literature 2 below describes a technique in which when correcting aberrations that occur in an optical system such as a laser microscope, the amount of aberration correction is expressed as a phase distribution of each function of the Zernike polynomial, a phase modulation profile is calculated by changing the relative phase modulation amount of each function, and the phase modulation profile is generated by applying a voltage to electrodes provided in a phase modulation element. In addition, Patent Literature 3 below describes a technique for correcting the aberration of an eye to be examined in fundus examination, in which a coefficient for each order is calculated by modeling a wavefront measured by a wavefront sensor as a Zernike function and the modulation amount of a wavefront correction device is calculated based on the coefficient.

### CITATION LIST

### Patent Literature

Patent Literature 1: Japanese Unexamined Patent Publication No. 2011-133580
Patent Literature 2: International Publication WO 2013/172085
Patent Literature 3: Japanese Unexamined Patent Publication No. 2012-235834

### SUMMARY OF INVENTION

### Technical Problem

In the conventional techniques described above, the amount of calculation when deriving coefficients for aberration correction tends to increase, and the calculation time also tends to increase. Therefore, it is required to shorten the calculation time when realizing the aberration correction.

Therefore, one aspect of the embodiments has been made in view of such problems, and an object thereof is to provide a light correction coefficient prediction method, a light correction coefficient prediction device, a machine learning method, a pre-processing method in machine learning, and a trained learning model that enable efficient correction of optical aberrations in a short calculation time.

### Solution to Problem

A light correction coefficient prediction method according to one aspect of embodiments includes: a step in which, for an intensity image obtained by observing an action caused by light corrected using a light modulator based on a light correction coefficient, an intensity distribution that is a distribution of intensities in a plurality of regions of interest within a predetermined range on the intensity image is acquired; a step of calculating a comparison result between the intensity distribution and a target distribution to generate comparison data; and a step of predicting a light correction coefficient, which is for performing aberration correction related to the light so that the intensity distribution approaches the target distribution, by inputting the comparison data and the light correction coefficient, which is a basis of the intensity distribution, to a learning model.

Alternatively, a light correction coefficient prediction device according to another aspect of the embodiments includes: an acquisition unit that acquires, for an intensity image obtained by observing an action caused by light corrected using a light modulator based on a light correction coefficient, an intensity distribution that is a distribution of intensities in a plurality of regions of interest within a predetermined range on the intensity image; a generation unit that calculates a comparison result between the intensity distribution and a target distribution to generate comparison data; and a prediction unit that predicts a light correction coefficient, which is for performing aberration correction related to the light so that the intensity distribution approaches the target distribution, by inputting the comparison data and the light correction coefficient, which is a basis of the intensity distribution, to a learning model.

Alternatively, a machine learning method according to another aspect of the embodiments includes: a step in which, for an intensity image obtained by observing an action caused by light corrected using a light modulator based on a light correction coefficient, an intensity distribution that is a distribution of intensities in a plurality of regions of interest within a predetermined range on the intensity image is acquired; a step of calculating a comparison result between the intensity distribution and a target distribution to generate comparison data; and a step of training a learning model to output a light correction coefficient, which is for performing aberration correction related to the light so that the intensity distribution approaches the target distribution, by inputting the comparison data and the light correction coefficient, which is a basis of the intensity distribution, to the learning model.

Alternatively, a pre-processing method in machine learning according to another aspect of the embodiments is a pre-processing method in machine learning for generating data to be input to the learning model used in the machine learning method according to the above aspect, and includes: a step in which, for an intensity image obtained by observing an action caused by light corrected using a light modulator based on a light correction coefficient, an intensity distribution that is a distribution of intensities in a plurality of regions of interest within a predetermined range on the intensity image is acquired; a step of calculating a comparison result between the intensity distribution and a target distribution to generate comparison data; and a step of concatenating the comparison data and the light correction coefficient, which is a basis of the intensity distribution.

Alternatively, a trained learning model according to another aspect of the embodiments is a learning model built by training using the machine learning method according to the above aspect.

According to any of the above one aspect and other aspects, the intensity distribution in a plurality of regions of interest on the intensity image is acquired from the intensity image obtained by observing the action caused by the light whose wavefront has been corrected using the light modulator, comparison data between the intensity distribution and the target distribution is generated, and the light correction coefficient, which is a basis for correction by the light modulator, and the comparison data are input to the learning model. Therefore, for a learning model that predicts a light correction coefficient with which it is possible to realize correction so that the intensity distribution between a plurality of regions of interest approaches the target distribution, it is possible to input data that has the amount of data compressed from the intensity image and accurately reflects the intensity distribution between a plurality of regions of interest. As a result, it is possible to shorten the calculation time during learning of the learning model or prediction of the light correction coefficient and realize highly accurate aberration correction.

### Advantageous Effects of Invention

According to one aspect of the present disclosure, it is possible to efficiently correct optical aberrations in a short calculation time.

### BRIEF DESCRIPTION OF DRAWINGS

FIG. 1 is a schematic configuration diagram of an optical system 1 according to a first embodiment.

FIG. 2 is a block diagram showing an example of the hardware configuration of a control device 11 in FIG. 1.

FIG. 3 is a block diagram showing the functional configuration of the control device 11 in FIG. 1.

FIG. 4 is a diagram showing an example of an intensity image input from an imaging element 7 in FIG. 1.

FIG. 5 is a graph of intensity distribution represented by intensity distribution data acquired by an acquisition unit 201 in FIG. 3.

FIG. 6 is a flowchart showing a procedure of learning processing in the optical system 1.

FIG. 7 is a flowchart showing a procedure of observation processing in the optical system 1.

FIG. 8 is a block diagram showing the functional configuration of a control device 11A according to a second embodiment.

FIG. 9 is a block diagram showing the functional configuration of a control device 11A according to a third embodiment.

FIG. 10 is a schematic configuration diagram of an optical system 1A according to a modification example.

FIG. 11 is a schematic configuration diagram of an optical system 1B according to a modification example.

FIG. 12 is a schematic configuration diagram of an optical system 1C according to a modification example.

FIG. 13 is a schematic configuration diagram of an optical system 1D according to a modification example.

FIG. 14 is a schematic configuration diagram of an optical system 1E according to a modification example.

FIG. 15 is a schematic configuration diagram of an optical system 1F according to a modification example.

FIG. 16 is a diagram showing an example of an intensity image input from an imaging element 7 in a modification example.

FIG. 17 is a graph of intensity distribution represented by intensity distribution data acquired in a modification example.

FIG. 18 is a diagram showing an example of an intensity image input from an imaging element 7 in a modification example.

FIG. 19 is a graph of intensity distribution represented by intensity distribution data acquired in a modification example.

### DESCRIPTION OF EMBODIMENTS

Hereinafter, embodiments of the present disclosure will be described in detail with reference to the accompanying diagrams. In addition, in the description, the same elements or elements having the same functions are denoted by the same reference numerals, and repeated descriptions thereof will be omitted.

### First Embodiment

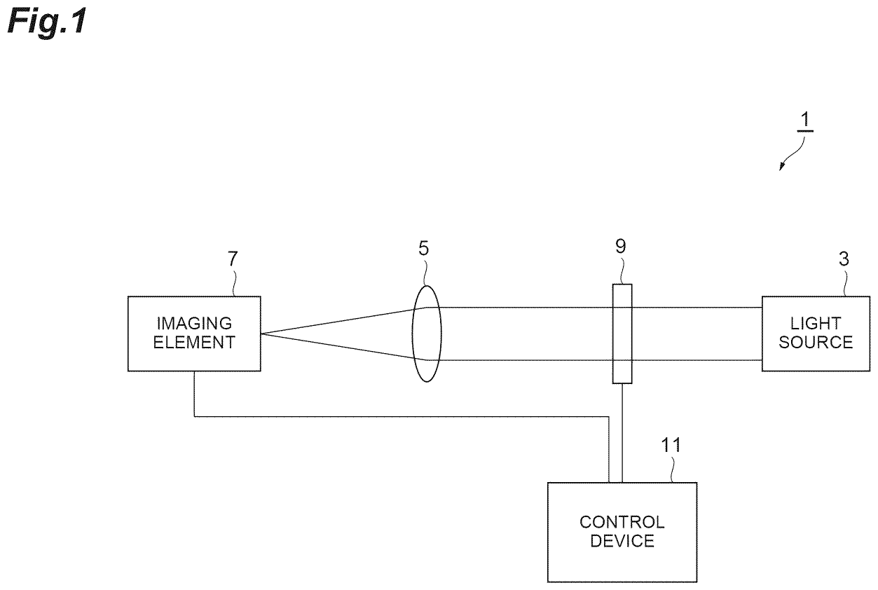

FIG. 1 is a configuration diagram of an optical system 1 according to a first embodiment. The optical system 1 is an optical system for emitting light to a sample in order to observe the sample. As shown in FIG. 1, the optical system 1 includes: a light source 3 that generates coherent light such as laser light; a condensing lens 5 for condensing light emitted from the light source 3; an imaging element 7 such as a CCD (Charge Coupled Device) camera and a CMOS (Complementary Metal Oxide Semiconductor) camera that is arranged at the focal position of the condensing lens 5 and that detects (observes) a two-dimensional intensity distribution generated by the action of the light from the light source 3 and outputs an intensity image showing the intensity distribution; a spatial light modulator 9 that is arranged on the optical path of light between the light source 3 and the condensing lens 5 to modulate the spatial distribution of the phase of light; and a control device 11 connected to the imaging element 7 and the spatial light modulator 9. In the optical system 1 configured as described above, after the setting process related to aberration correction is completed by the control device 11 based on the intensity image output from the imaging element 7, the sample to be observed is placed at the focal position of the condensing lens 5, instead of the imaging element 7, for actual observation.

The spatial light modulator 9 provided in the optical system 1 is, for example, a device having a structure in which liquid crystal is arranged on a semiconductor substrate. This is an optical element capable of spatially modulating the phase of incident light and outputting phase-modulated light by making it possible to control the voltage applied to each pixel on the semiconductor substrate. The spatial light modulator 9 is configured to be able to receive a phase image from the control device 11, and operates to perform phase modulation corresponding to the brightness distribution in the phase image.

In the present embodiment, the spatial light modulator 9 has a role of generating an optical vortex by modulating a wavefront of laser light emitted from the light source 3 into a helical wavefront, for example. The optical vortex is light having a helical wavefront centered on the light propagation axis. Specifically, the spatial light modulator 9 generates a Laguerre-Gauss mode beam. The Laguerre-Gauss mode beam is a beam having a ring-shaped intensity distribution in a direction perpendicular to the propagation axis. An ideal Laguerre-Gauss mode beam has a uniform intensity in the circumferential direction centered on the propagation axis. However, the optical vortex generated in the optical system 1 is strongly influenced by the optical aberrations in the optical system 1. For this reason, in order to realize an ideal intensity distribution, that is, a uniform intensity distribution, in the optical system 1, aberration correction is essential.

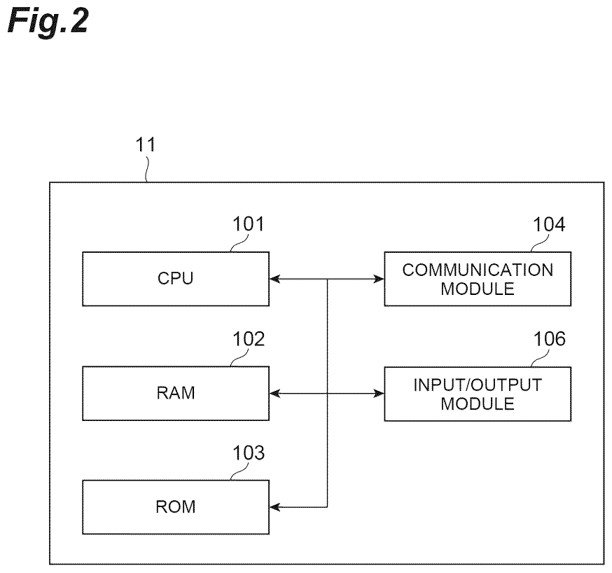

The control device 11 is a light correction coefficient prediction device of the present embodiment. For example, the control device 11 is a computer such as a PC (Personal Computer). FIG. 2 shows the hardware configuration of the control device 11. As shown in FIG. 2, the control device 11 is physically a computer including a CPU (Central Processing Unit) 101 as a processor, a RAM (Random Access Memory) 102 or a ROM (Read Only Memory) 103 as a recording medium, a communication module 104, an input/output module 106, and the like, which are electrically connected to each other. In addition, the control device 11 may include a display, a keyboard, a mouse, a touch panel display, and the like as input devices and display devices, and may include a data recording device, such as a hard disk drive and a semiconductor memory. In addition, the control device 11 may be configured by a plurality of computers.

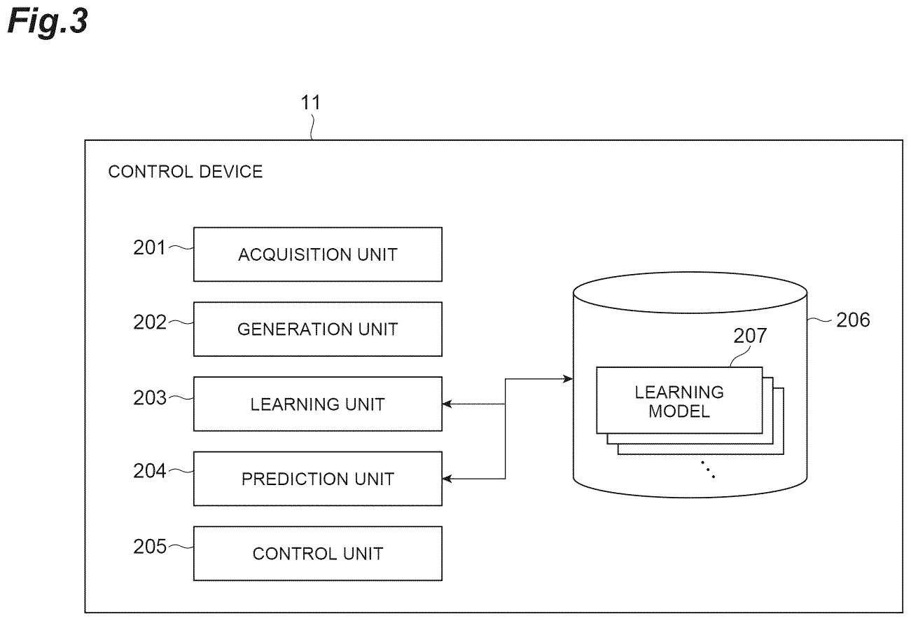

FIG. 3 is a block diagram showing the functional configuration of the control device 11. The control device 11 includes an acquisition unit 201, a generation unit 202, a learning unit 203, a prediction unit 204, a control unit 205, and a model storage unit 206. Each functional unit of the control device 11 shown in FIG. 3 is realized by reading a program onto the hardware, such as the CPU 101 and the RAM 102, and by operating the communication module 104, the input/output module 106, and the like and performing data reading and writing in the RAM 102 under the control of the CPU 101. The CPU 101 of the control device 11 executes the computer program so that the control device 11 functions as each functional unit shown in FIG. 3, thereby sequentially executing processing corresponding to a light correction coefficient prediction method, a machine learning method, and a pre-processing method in machine learning, which will be described later. In addition, the CPU may be a single piece of hardware, or may be implemented in a programmable logic such as an FPGA, like a soft processor. The RAM or the ROM may be stand-alone hardware, or may be built in a programmable logic such as an FPGA. Various kinds of data necessary for executing the computer program and various kinds of data generated by executing the computer program are all stored in a built-in memory, such as the ROM 103 and the RAM 102, or a storage medium, such as a hard disk drive.

In addition, in the control device 11, a learning model 207 used for executing the light correction coefficient prediction method and the machine learning method is stored in advance in the model storage unit 206 by being read by the CPU 101. The learning model 207 is a learning model for predicting a light correction coefficient, which will be described later, by machine learning. Machine learning includes supervised learning, deep learning, reinforcement learning, neural network learning, and the like. In the present embodiment, a convolutional neural network is adopted as an example of a deep learning algorithm for realizing a learning model. The convolutional neural network is an example of deep learning having a structure including an input layer, a convolutional layer, a pooling layer, a fully connected layer, a dropout layer, an output layer, and the like. However, as the learning model 207, algorithms such as an RNN (Recurrent Neural Network) and an LSTM (Long Short-Term Memory) may be adopted. After being downloaded to the control device 11, the learning model 207 is built by machine learning in the control device 11 and updated to a trained learning model.

Hereinafter, details of the function of each functional unit of the control device 11 will be described.

The acquisition unit 201 sequentially sets a plurality of regions of interest (ROIs) for the intensity image input from the imaging element 7. For example, the acquisition unit 201 fits the brightness distribution in the intensity image with a circle, and specifies the coordinates of the center (center coordinates) of the circle on the image. Then, the acquisition unit 201 sets a fan-shaped ROI with a predetermined central angle (for example, 5 degrees) around the center coordinates. In addition, the acquisition unit 201 sequentially sets a plurality of ROIs by sequentially rotating (shifting) the ROI counterclockwise (in a predetermined direction) by a predetermined angle (for example, 5 degrees) up to 360 degrees with the center coordinates as a reference. Then, the acquisition unit 201 calculates a sum of brightness values of pixels in the plurality of set ROIs, and acquires the distribution (profile) of the sum of the brightness values between the plurality of ROIs as intensity distribution data. At this time, the acquisition unit 201 may calculate an average value and a standard deviation of the sum of the brightness values and normalize the distribution (brightness) of the plurality of ROIs so that the average value of the intensity distribution data is 0 and the standard deviation of the data is 1. Alternatively, the acquisition unit 201 may specify a maximum value of the sum of the brightness values and normalize the distribution of the plurality of ROIs with the maximum value.

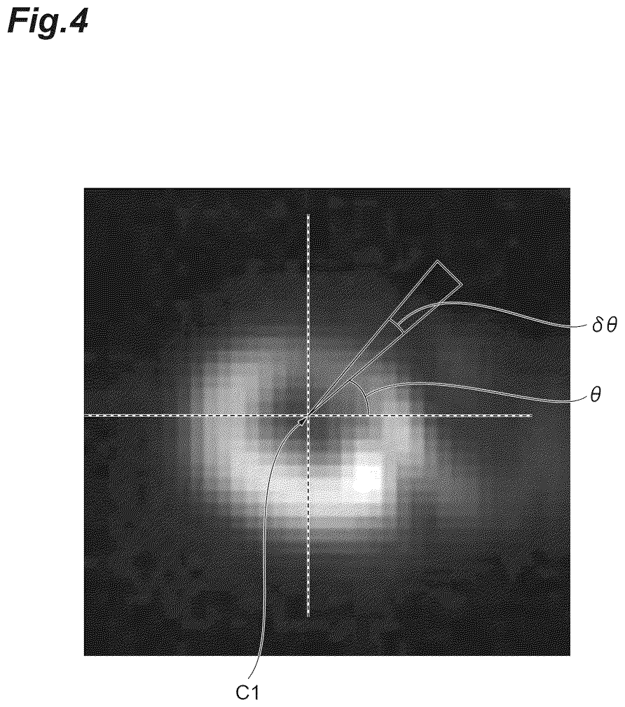

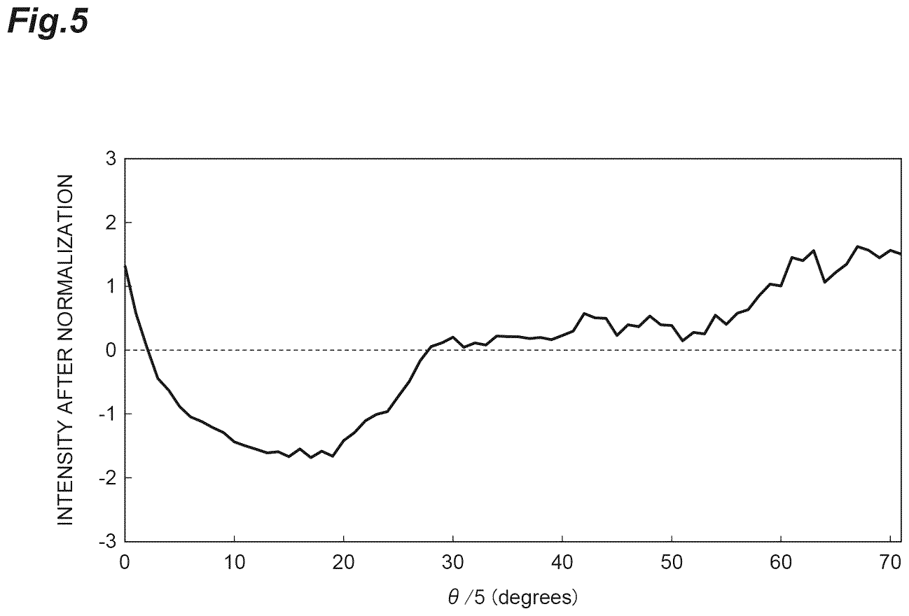

FIG. 4 is a diagram showing an example of an intensity image input from the imaging element 7, and FIG. 5 is a graph of intensity distribution represented by intensity distribution data acquired by the acquisition unit 201. Thus, in the intensity image, for example, the intensity distribution of laser light formed in an optical vortex having a ring-shaped intensity distribution by the optical system 1 is obtained. The acquisition unit 201 sets a fan-shaped ROI with a central angle δθ centered on the center C1 of the brightness distribution on the intensity image, and sets a plurality of ROIs by shifting a rotation angle θ from a reference line passing through the center of the ROI from 0 degrees to 360 degrees. In addition, the acquisition unit 201 acquires the data of the intensity distribution between a plurality of ROIs corresponding to the rotation angle θ (0 degrees≤θ<360 degrees) shown in FIG. 5 as one-dimensionally arranged data.

Returning to FIG. 3, the generation unit 202 calculates difference data, which is comparison data obtained by comparing the intensity distribution data acquired by the acquisition unit 201 and target data of the intensity distribution set in advance. For example, as the target data of the intensity distribution, an intensity distribution between ideal rotation angles θ for an optical vortex having a ring-shaped intensity distribution, that is, a constant intensity distribution with respect to the rotation angle θ is set in advance. The generation unit 202 calculates a difference value for each rotation angle θ between the data of the intensity distribution and the target data of the intensity distribution, and generates difference data by one-dimensionally arranging the calculated difference values. For example, when the target data of the intensity distribution is set to have a constant normalized intensity “0” with respect to the rotation angle θ, the generation unit 202 generates difference data so that the difference data is equal to the intensity distribution data acquired by the acquisition unit 201. In addition, as the comparison data, the generation unit 202 may calculate a division value for each rotation angle θ between the concatenated data of the intensity distribution and the target data of the intensity distribution, instead of the difference data.

In addition, the target data used for generating the difference data by the generation unit 202 may be set to data corresponding to various intensity distributions. For example, the target data used for generating the difference data by the generation unit 202 may be data corresponding to the intensity distribution of laser light focused at one point having a Gaussian distribution, may be data corresponding to the intensity distribution of laser light focused at multiple points, or may be data corresponding to the intensity distribution of laser light with a striped pattern.

The control unit 205 controls the phase modulation of the spatial light modulator 9 when the processing corresponding to the light correction coefficient prediction method, the machine learning method, and the pre-processing method in machine learning is executed by the control device 11. That is, when the processing corresponding to the light correction coefficient prediction method is executed, the control unit 205 controls the phase modulation of the spatial light modulator 9 so as to add phase modulation opposite to the aberration so that the aberration caused by the optical system of the optical system 1 is canceled out. During the execution of the processing corresponding to the light correction coefficient prediction method, the machine learning method, and the pre-processing method in machine learning, the control unit 205 sets a phase image, which is to be given to the spatial light modulator 9 for aberration correction, based on the shape of the wavefront calculated by using a Zernike polynomial. The Zernike polynomial is an orthogonal polynomial defined on the unit circle, and is a polynomial used for correcting aberrations because the Zernike polynomial has terms corresponding to Seidel's five aberrations known as monochromatic aberrations. More specifically, the control unit 205 sets a plurality of Zernike coefficients (for example, six Zernike coefficients) of the Zernike polynomial as light correction coefficients, calculates the shape of the wavefront based on the Zernike coefficients, and controls the spatial light modulator 9 by using a phase image corresponding to the shape.

The learning unit 203 has a function of performing the following processing when executing the processing corresponding to the machine learning method and the pre-processing method in the machine learning. That is, the learning unit 203 continuously changes a combination of values of a plurality of Zernike coefficients used for the phase modulation control of the control unit 205 to a combination of different values, and sets the control of the control unit 205 so that the phase modulation is controlled by the combination of the values. Then, the learning unit 203 acquires difference data, which is generated by the generation unit 202 according to the phase modulation control of the control unit 205, for each combination of Zernike coefficient values. In addition, the learning unit 203 generates a plurality of pieces of input data by one-dimensionally concatenating a combination of values of Zernike coefficients corresponding to the difference data to the difference data, and builds the learning model 207 by machine learning (training) using the plurality of pieces of input data as learning data and training data for the learning model 207 stored in the model storage unit 206. Specifically, the learning unit 203 updates parameters such as a weighting factor in the learning model 207 so as to predict the Zernike coefficients that bring the difference data closer to zero-value continuous data, that is, bring the intensity distribution closer to the target intensity distribution. By building such a learning model, it is possible to build a trained learning model for predicting a light correction coefficient that enables the transition to the target intensity distribution by repeating the comparison between the light correction coefficient predicted to be required for the transition to the target data and the light correction coefficient actually required.

The prediction unit 204 has a function of performing the following processing when executing the processing corresponding to the light correction coefficient prediction method. That is, the prediction unit 204 sets a combination of values of a plurality of Zernike coefficients used for the phase modulation control of the control unit 205 to predetermined values set in advance or values input by the operator (user) of the control device 11, and sets the control of the control unit 205 so that the phase modulation is controlled by the combination of the values. Then, the prediction unit 204 acquires difference data generated by the generation unit 202 according to the phase modulation control of the control unit 205. In addition, the prediction unit 204 generates input data by one-dimensionally concatenating a combination of values of Zernike coefficients used for the phase modulation control of the control unit 205 to the difference data, and inputs the input data to the trained learning model 207 stored in the model storage unit 206 so that the learning model 207 outputs a predicted value of the combination of the values of the Zernike coefficients. That is, by using the learning model 207, the prediction unit 204 predicts a combination of Zernike coefficient values that brings the intensity distribution closer to the target intensity distribution. In addition, the prediction unit 204 sets the control of the control unit 205 so that the phase modulation is controlled by the predicted combination of Zernike coefficient values when observing the actual sample.

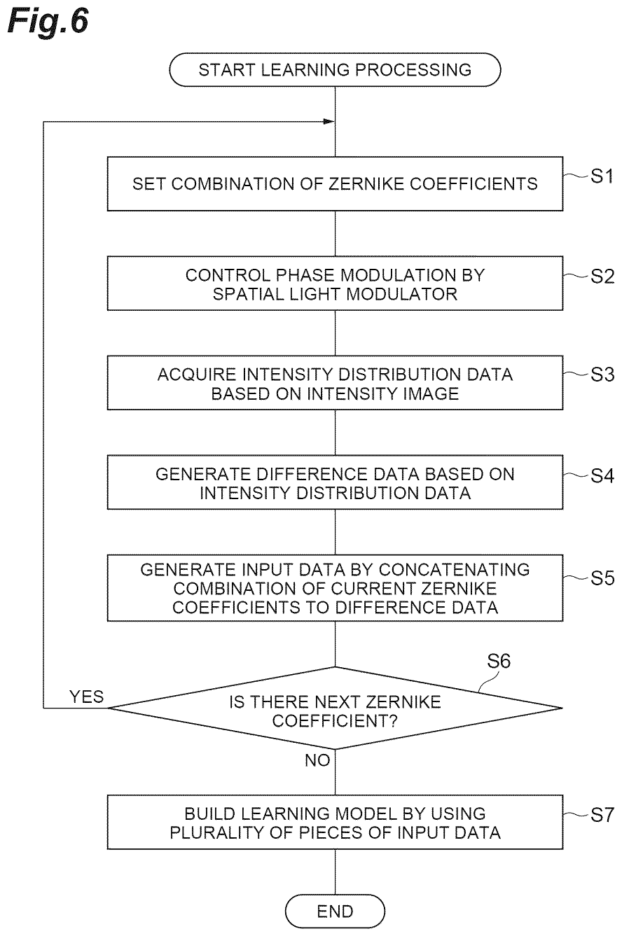

Next, the procedure of learning processing in the optical system 1 according to the present embodiment, that is, the flow of the machine learning method and the pre-processing method in machine learning according to the present embodiment will be described. FIG. 6 is a flowchart showing the procedure of learning processing by the optical system 1.

First, when an instruction to start learning processing is received from an operator, the control device 11 sets a combination of values of Zernike coefficients for controlling the phase modulation of the spatial light modulator 9 to an initial value (step S1). Then, the control unit 205 of the control device 11 controls the spatial light modulator 9 to perform phase modulation based on the set combination of Zernike coefficient values (step S2).

In addition, the acquisition unit 201 of the control device 11 acquires intensity distribution data based on the intensity image of the phase-modulated light (step S3). Thereafter, the generation unit 202 of the control device 11 generates difference data by calculating a difference value between the intensity distribution data and the target data (step S4).

In addition, the learning unit 203 of the control device 11 generates input data by concatenating, to the difference data, a combination of current Zernike coefficient values used for phase modulation control when generating the difference data (step S5). Then, the learning unit 203 determines whether or not there is a next set value of the combination of Zernike coefficient values (step S6). As a result of the determination, if it is determined that there is a next set value (step S6; YES), the processing of steps S1 to S5 is repeated to generate input data for the next combination of Zernike coefficient values. Then, when input data is generated for a predetermined number of combinations of Zernike coefficient values (step S6; NO), the learning unit 203 builds the learning model 207 by using the plurality of pieces of generated input data as learning data and training data (step S7: execution of training). However, for example, when the expert has previously acquired the Zernike coefficients and the intensity image corresponding to the coefficients, it is possible to omit the execution of phase modulation by the spatial light modulator 9 in step S2 above and the acquisition of the intensity image by the acquisition unit 201 in step S3. Instead, a combination of the Zernike coefficients and the intensity images acquired in advance can be used.

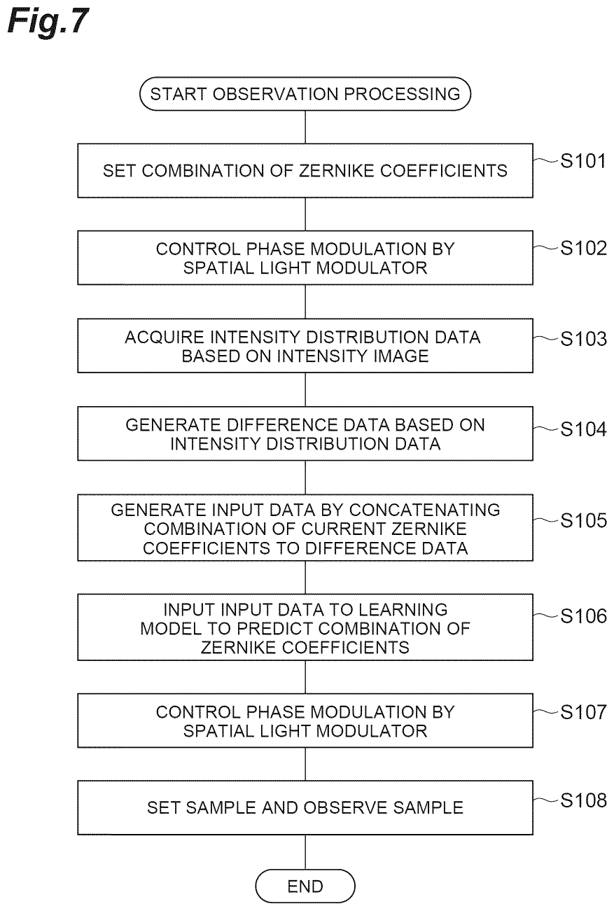

Next, the procedure of observation processing in the optical system 1 according to the present embodiment, that is, the flow of the light correction coefficient prediction method according to the present embodiment will be described. FIG. 7 is a flowchart showing the procedure of observation processing by the optical system 1.

First, when an instruction to start preset processing before observation is received from an operator, the control device 11 sets a combination of values of Zernike coefficients for controlling the phase modulation of the spatial light modulator 9 to a predetermined value (step S101). Then, the control unit 205 of the control device 11 controls the spatial light modulator 9 to perform phase modulation based on the set combination of Zernike coefficient values (step S102).

In addition, the acquisition unit 201 of the control device 11 acquires intensity distribution data based on the intensity image of the phase-modulated light (step S103). Thereafter, the generation unit 202 of the control device 11 generates difference data by calculating a difference value between the intensity distribution data and the target data (step S104).

In addition, the prediction unit 204 of the control device 11 generates input data by concatenating, to the difference data, a combination of current Zernike coefficient values used for phase modulation control when generating the difference data (step S105). Then, the prediction unit 204 inputs the generated input data to the trained learning model 207 to predict a combination of Zernike coefficient values that brings the intensity distribution closer to the target intensity distribution (step S106). In order to improve the accuracy of prediction, the above processing of steps S101 to S106 may be repeated multiple times as necessary.

Thereafter, the control unit 205 of the control device 11 controls the phase modulation of the spatial light modulator 9 based on the predicted combination of Zernike coefficient values (step S107). Finally, a sample to be observed is set in the optical system 1, and the sample is observed by using the phase-modulated light (step S108).

According to the optical system 1 described above, the intensity distribution between a plurality of ROIs is acquired from the intensity image obtained by observing the optical vortex whose wavefront has been corrected by using the spatial light modulator 9, the difference data between the intensity distribution and the target distribution is generated, and the light correction coefficient and the difference data thereof, which are the basis of the correction by the light modulator, are input to the learning model. Therefore, it is possible to input data that accurately reflects the intensity distribution between a plurality of ROIs, which is data obtained by compressing the data amount from the intensity image, to the learning model 207 that predicts the Zernike coefficients with which it is possible to realize wavefront correction so that the intensity distribution between the plurality of ROIs approaches the target intensity distribution. As a result, it is possible to shorten the calculation time during learning of the learning model 207 or prediction of the Zernike coefficients and realize highly accurate aberration correction. That is, the conventional method of using an image as an input of a learning model tends to result in an increase in learning time, an increase in prediction time, and an increase in calculation resources required during learning and prediction. On the other hand, in the present embodiment, it is possible to shorten the calculation time during learning and prediction and reduce the calculation resources.

In the optical system 1, the coefficients of the Zernike polynomial to give the shape of the wavefront of light are used as light correction coefficients used for phase modulation control. In this case, highly accurate aberration correction can be realized by correction based on the Zernike coefficients predicted by the learning model.

In addition, in the optical system 1, the intensity distribution is acquired as a brightness distribution by calculating the sum of the brightness values of pixels for each of a plurality of ROIs. In this case, data that more accurately reflects the intensity distribution between the plurality of ROIs based on the intensity image can be input to the learning model that predicts the Zernike coefficients. As a result, it is possible to realize more accurate aberration correction.

In particular, in the optical system 1, the intensity distribution is acquired as a distribution between a plurality of ROIs set by sequential shifting along a predetermined direction on the intensity image. In this case, data that more accurately reflects the intensity distribution along a predetermined direction based on the intensity image can be input to the learning model that predicts the Zernike coefficients. As a result, it is possible to realize more accurate aberration correction.

In addition, in the optical system 1, the data obtained by simply one-dimensionally concatenating the difference data, which is continuous data, and the current light correction coefficient is used as an input of the learning model. With such a simple data input method, a light correction coefficient that brings the intensity distribution closer to the target intensity distribution can be predicted in a short calculation time. In particular, in the present embodiment, as the learning model 207, a convolutional neural network algorithm model is adopted. According to such a learning model 207, differences in meaning of input data (separation of different types of data) are automatically recognized. Therefore, it is possible to efficiently build a learning model.

### Second Embodiment

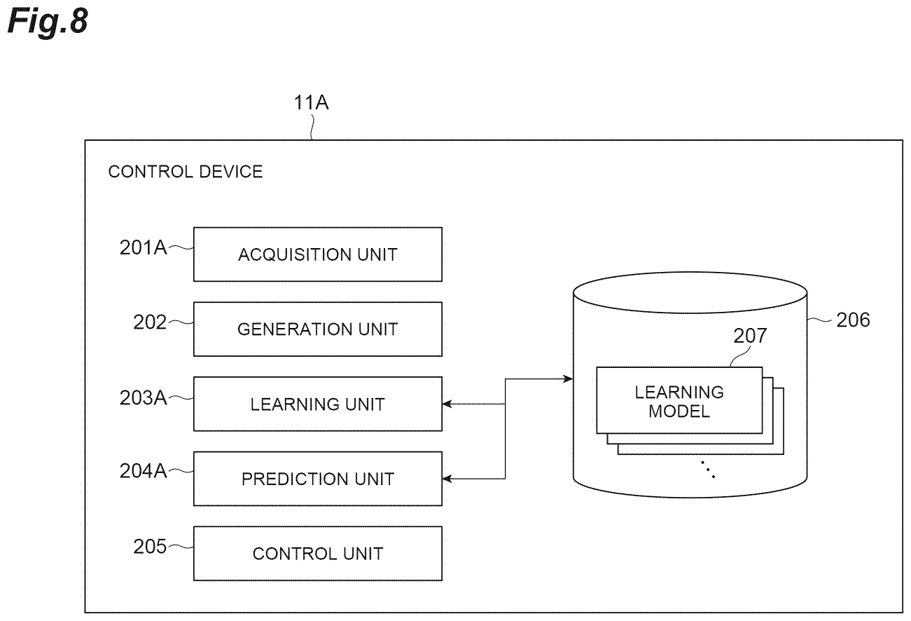

Next, another form of the control device 11 will be described. FIG. 8 is a block diagram showing the functional configuration of a control device 11A according to a second embodiment. In the control device 11A according to the second embodiment, the functions of an acquisition unit 201A, a learning unit 203A, and a prediction unit 204A are different from those in the first embodiment. Only the differences from the first embodiment will be described below.

The acquisition unit 201A further acquires parameters that contribute to aberrations caused by the optical system of the optical system 1. At this time, the acquisition unit 201A may acquire the parameters from a sensor provided in the optical system 1, or may acquire the parameters by receiving an input from the operator of the control device 11. As such parameters, the acquisition unit 201A acquires, for example, parameters related to direct factors, such as the position, magnification, focal length, and refractive index of each lens that makes up the optical system and the wavelength of light emitted from the light source 3, and parameters related to indirect factors, such as temperature, humidity, time, and elapsed time from any point in time. In this case, the acquisition unit 201A may acquire one type of parameter, or may acquire a plurality of types of parameters.

When building the learning model 207, the learning unit 203A concatenates the parameters acquired by the acquisition unit 201A to each of the plurality of pieces of input data, and builds the learning model 207 by using the plurality of pieces of input data to which the parameters are concatenated. The prediction unit 204A concatenates the parameters acquired by the acquisition unit 201A to the input data and inputs the input data to which the parameters are concatenated to the trained learning model 207, thereby predicting a combination of Zernike coefficient values.

According to the control device 11A according to the second embodiment, it is possible to build a robust learning model that is resistant to changes in factors, such as an environment, in the optical system 1. The relationship between the intensity distribution and the light correction coefficient included in the learning data used in the first embodiment includes aberration information of the optical system when the learning data is acquired. However, the aberration may change due to changes in factors, such as misalignment of the optical axis of the optical system. As a result, between when the learning model is built (during learning) and when aberration correction is performed (during observation processing), there may be a difference in the aberration of the optical system due to changes in factors. Such a difference in aberration can lead to a decrease in prediction accuracy of the Zernike coefficients. According to the second embodiment, it is possible to reduce the difference in aberration correction between the time of learning and the time of observation processing by concatenating the parameters, which are factors that change the aberration of the optical system, to learning data and input data. As a result, it is possible to realize more accurate aberration correction so as to approach the target intensity distribution.

In particular, in the present embodiment, as the learning model 207, a convolutional neural network algorithm model is adopted. According to such a learning model 207, differences in meaning of input data to which parameters are concatenated (separation of data from concatenated parameters) are automatically recognized. Therefore, it is possible to efficiently build a learning model. In addition, it is possible to concatenate parameters, which are thought to affect correction, to the input data. Therefore, it is possible to realize aberration correction in consideration of the effects of parameters that humans have not been able to find a relationship with.

### Third Embodiment

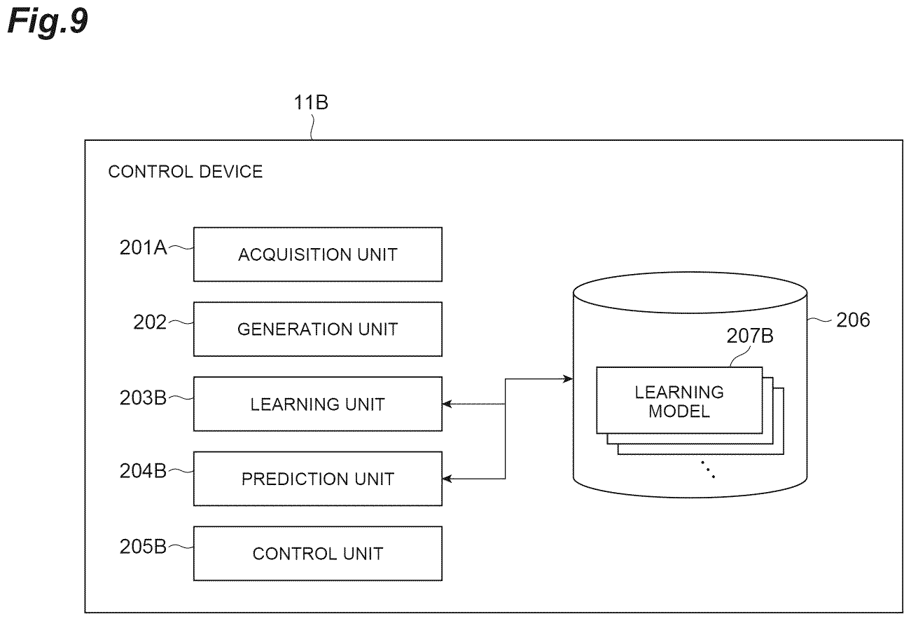

Next, still another form of the control device 11 will be described. FIG. 9 is a block diagram showing the functional configuration of a control device 11B according to a third embodiment. In the control device 11B according to the third embodiment, the functions of a learning unit 203B, a prediction unit 204B, and a control unit 205B are different from those in the second embodiment. Only the differences from the second embodiment will be described below.

In addition to controlling the spatial light modulator 9, the control unit 205B also has a function of adjusting additional parameters that contribute to optical aberrations in the optical system 1. For example, the control unit 205B has a function of adjusting the position of the lens in the optical system as such an additional parameter through a position adjustment function provided in the optical system 1. As parameters that contribute to aberrations other than the position of the lens in the optical system, the additional parameters may be parameters that can be adjusted in the optical system 1, such as the arrangement of components that make up the optical system, the magnification, focal length, and refractive index of each lens that makes up the optical system, and the wavelength of light emitted from the light source 3. In addition, a plurality of types of parameters may be included, without being limited to one type of additional parameter.

When building a learning model 207B, the learning unit 203B uses a plurality of pieces of input data to which parameters including additional parameters are concatenated in the same manner as in the second embodiment, thereby building the learning model 207B capable of outputting predicted values of the additional parameters, with which aberrations can be corrected, in addition to the combinations of Zernike coefficient values. The parameters used in the input data at this time may include a different type of parameter from the additional parameters. In addition, during learning, it is preferable to acquire the input data while actively changing the additional parameters.

The prediction unit 204B concatenates the parameters including the additional parameters to the input data and inputs the input data to which the parameters are concatenated to the trained learning model 207B, thereby predicting additional parameters for correcting aberrations in addition to a combination of Zernike coefficient values.

According to the control device 11B according to the third embodiment, it is possible to build a robust learning model that is resistant to changes in factors, such as an environment, in the optical system 1 by acquiring the predicted values of the adjustable additional parameters. That is, the aberrations of the optical system can be corrected by using other parameters that cause changes in the aberrations of the optical system. Therefore, it is possible to correct aberrations that are difficult to correct only with the Zernike coefficients.

While the various embodiments of the present disclosure have been described above, the present disclosure is not limited to the above-described embodiments, and can be modified or applied to others without departing from the scope described in the claims.

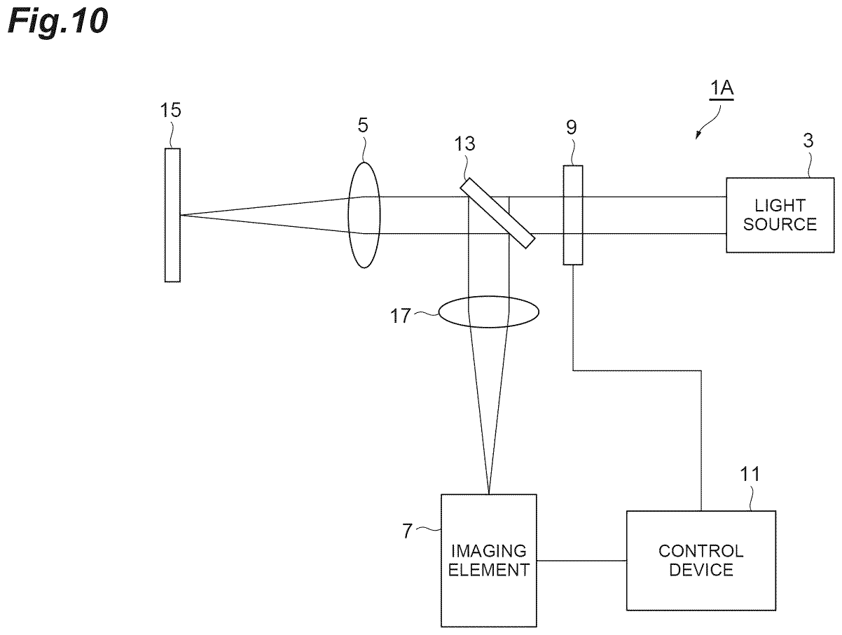

The optical system 1 according to each of the first to third embodiments described above may be modified as follows. FIGS. 10 to 15 are schematic configuration diagrams of optical systems 1A to 1F according to modification examples.

The optical system 1A shown in FIG. 10 is an example of an optical system that captures reflected light caused by the action of the light from the light source 3. The optical system 1A is different from the optical system 1 in that a mirror 15 arranged at the position of the imaging element 7, a half mirror 13 arranged between the spatial light modulator 9 and the condensing lens 5, and a condensing lens 17 for condensing reflected light reflected by the mirror 15 and the half mirror 13 toward the imaging element 7 are provided. With such a configuration as well, it is possible to realize highly accurate aberration correction based on the intensity image of the reflected light.

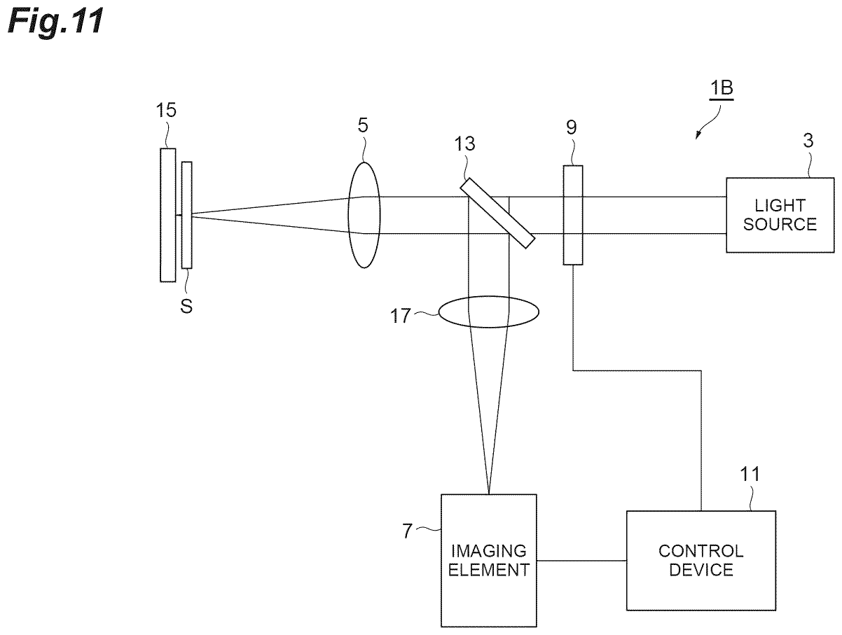

The optical system 1B shown in FIG. 11 is different from the optical system 1A in that a sample S to be observed is placed adjacent to the light source 3 side of the mirror 15 during building of the learning model and preset processing before observation. According to such a configuration, in the application of observing the inside of a sample with a large refractive index, it is possible to correct the aberration caused by the inside of the sample. Therefore, it is possible to improve the resolution in observation and the like.

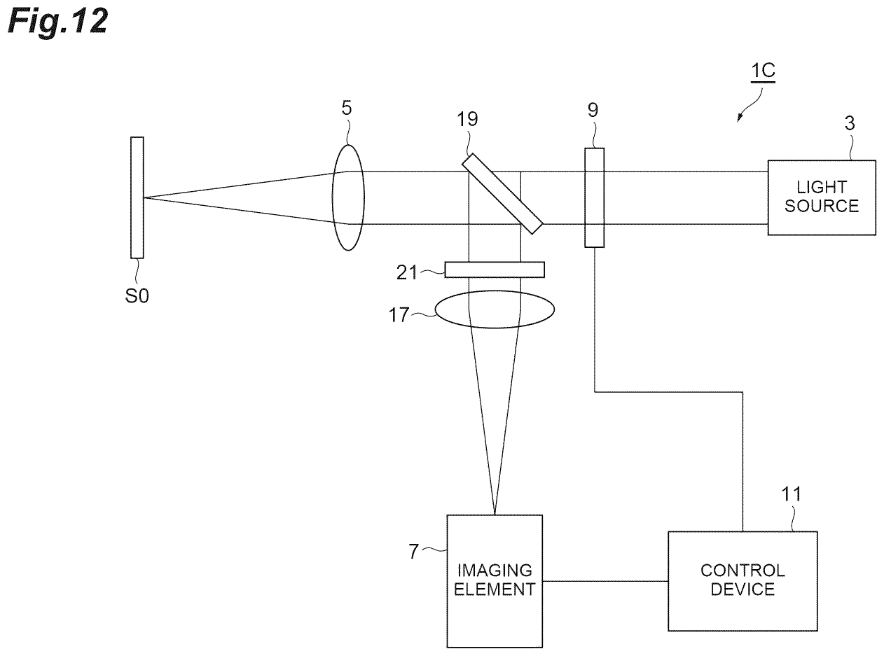

The optical system 1C shown in FIG. 12 is an example of an optical system that can be applied to observation of fluorescence excited by the action of the light from the light source 3. The optical system 1C has the same configuration as the optical system 1 as for the optical system of excitation light, and includes a dichroic mirror 19, an excitation light cut filter 21, and a condensing lens 17 as an optical system for fluorescence observation. The dichroic mirror 19 is provided between the spatial light modulator 9 and the condensing lens 5, and has a property of transmitting the excitation light and reflecting the fluorescence. The excitation light cut filter 21 transmits the fluorescence reflected by the dichroic mirror 19 and cuts the components of the excitation light. The condensing lens 17 is provided between the excitation light cut filter 21 and the imaging element 7, and condenses the fluorescence passing through the excitation light cut filter 21 toward the imaging element 7. In the optical system 1C having such a configuration, a standard sample S0, which emits uniform fluorescence with respect to the excitation light, is placed at the focal position of the condensing lens 5 during building of the learning model and preset processing before observation. With such a configuration, it is possible to realize highly accurate aberration correction in an optical system for observing fluorescence generated in a sample.

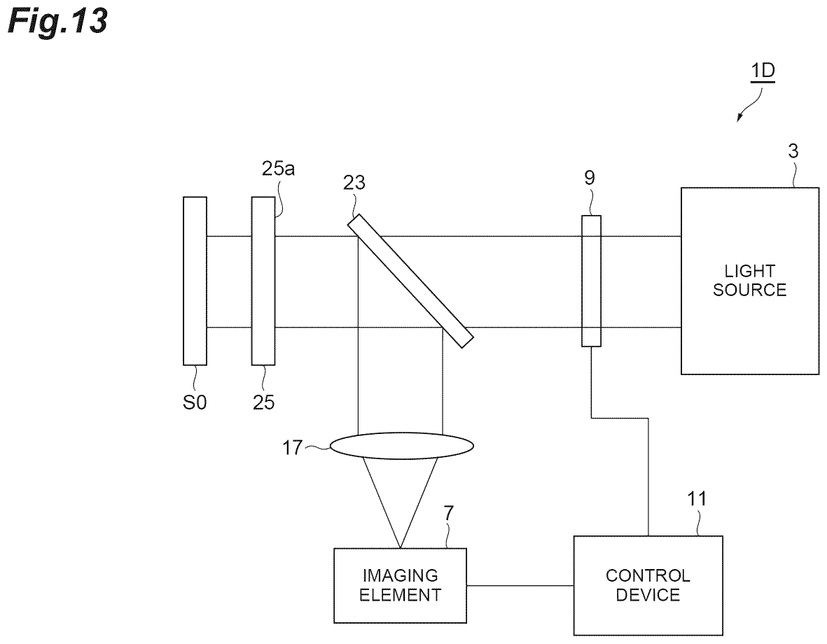

The optical system 1D shown in FIG. 13 is an example of an optical system capable of observing an interference image caused by the action of the light from the light source 3, and has the configuration of an optical system of a Fizeau interferometer. Specifically, the optical system 1D includes: a spatial light modulator 9 and a beam splitter 23 provided on the optical path of laser light from the light source 3; a reference plate 25 and a standard sample S0 arranged on the optical path of laser light passing through the spatial light modulator 9 and the beam splitter 23; and a condensing lens 17 and an imaging element 7 for observing an interference image, which is caused by two reflected light components generated by a reference surface 25a of the reference plate 25 and the surface of the standard sample S0, through the beam splitter 23. A flat reflective substrate can be used as the standard sample S0. With such an optical system 1D, it is possible to realize highly accurate aberration correction in an optical system for observing an interference image.

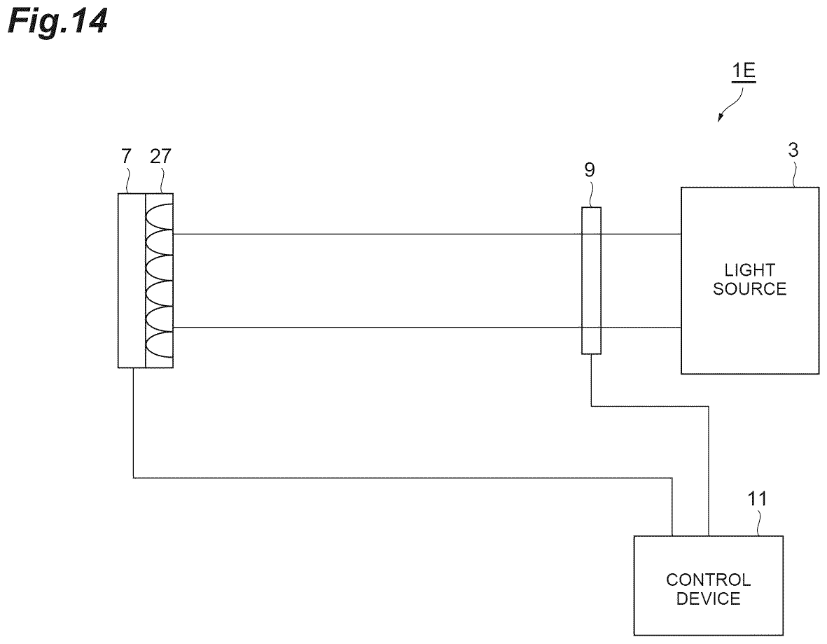

The optical system 1E shown in FIG. 14 is an example of an optical system that uses an image obtained by wavefront measurement for aberration correction of the optical system. Here, a Shack-Hartmann wavefront sensor is used in which a microlens array 27 is arranged in front of the imaging element 7 in order to obtain multi-point images caused by the action of the light from the light source 3. Thus, even with an optical system capable of acquiring an image obtained by wavefront measurement, it is possible to realize highly accurate aberration correction.

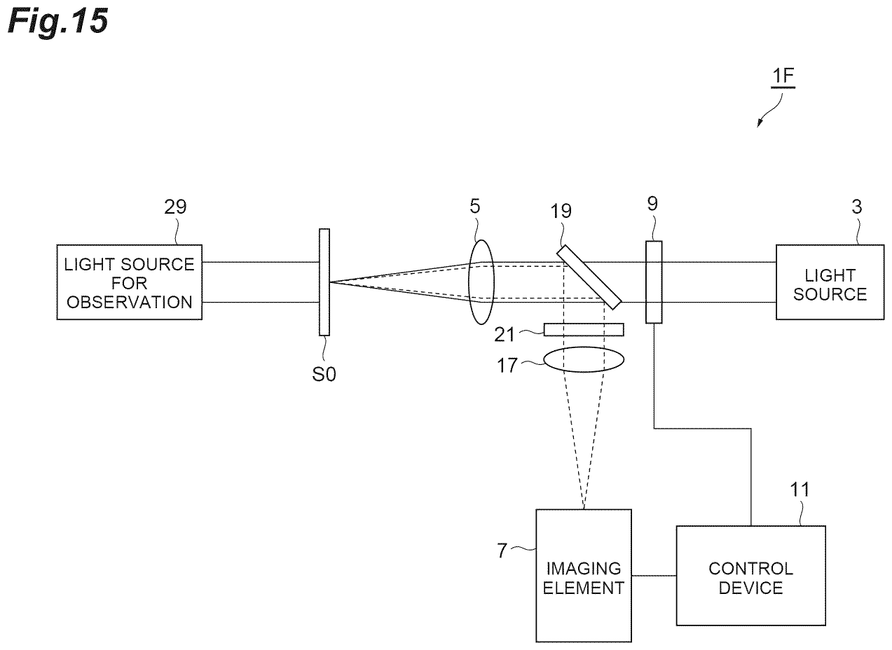

The optical system 1F shown in FIG. 15 is an example of an optical system that uses image data reflecting a phenomenon (action) caused by the emission of the laser light from the light source 3 instead of observing the laser light. For example, as an example of the phenomenon caused by the emission of the laser light, there is a laser processing phenomenon in which a material such as glass is processed (cutting, drilling, and the like) by focusing the laser light on the surface of the material. Also in the laser processing marks caused by the laser processing phenomenon, aberrations of the optical system may occur. Therefore, it is beneficial to correct the aberrations in order to perform the intended laser processing. The optical system 1F includes, in addition to the same configuration as the optical system 1C, a light source for observation 29 that emits observation light from the opposite side of the processing surface of the standard sample S0 such as a glass plate. With such a configuration, the laser processing mark of the standard sample S0 can be observed by detecting the scattered light generated by the observation light as an image with the imaging element 7. Thus, even with an optical system that allows a laser processing phenomenon to be observed as an image, it is possible to realize highly accurate aberration correction with respect to the laser light used for processing. In addition, as for laser processing, image data obtained as a result of observing the cross-sectional shape of a sample with scattered light, an SEM (scanning electron microscope), or the like may be used as learning data for correcting aberrations. With such an optical system capable of correcting aberrations, it is possible to realize laser processing capable of obtaining a desired cross-sectional shape.

In addition, in the optical system 1 according to each of the first to third embodiments described above, the acquisition units 201 and 201A may acquire the intensity distribution data as follows. That is, the acquisition units 201 and 201A may sequentially set a plurality of ROIs on the intensity image in a shape and arrangement set in advance and acquire the distribution of the sum of brightness values of pixels in each ROI as intensity distribution data. At this time, the acquisition units 201 and 201A may calculate an average value and a standard deviation of the sum of the brightness values and normalize the distribution between the ROIs so that the average value of the intensity distribution data is 0 and the standard deviation of the data is 1 or normalize the distribution between the ROIs with the maximum value.

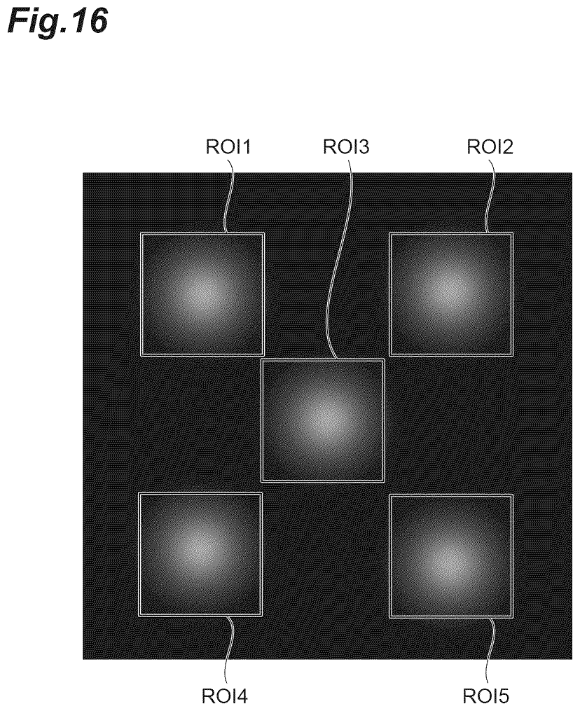

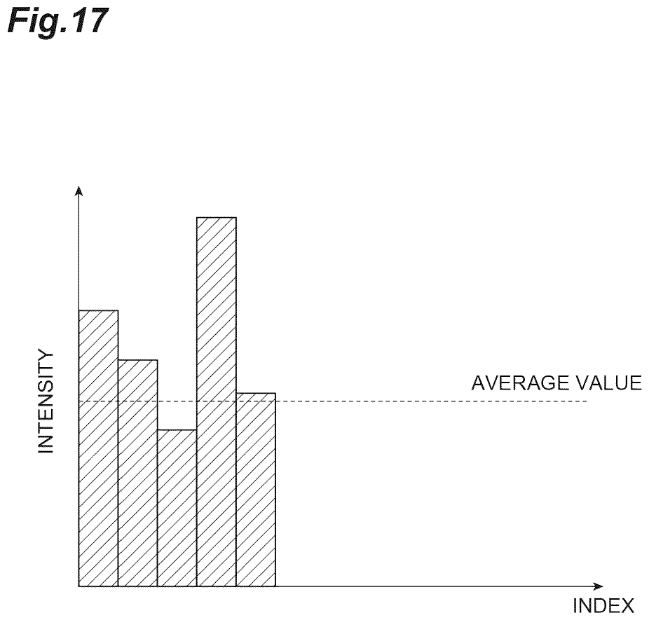

FIG. 16 is a diagram showing an example of an intensity image input from an imaging element, and FIG. 17 is a graph of intensity distribution represented by intensity distribution data acquired by the acquisition units 201 and 201A. Thus, by the acquisition units 201 and 201A, five ROIs ROI1 to ROI5 having rectangular shapes set in advance are arranged at coordinate positions set in advance on an intensity image. By processing the intensity image by the acquisition units 201 and 201A, intensity distribution data is obtained in which the intensity data for each index identifying the ROI is arranged one-dimensionally.

Similarly, the acquisition units 201 and 201A may sequentially set the positions of a plurality of ROIs by shifting the plurality of ROIs on the intensity image in a direction along a curve defined by a function set in advance and acquire the distribution of the sum of brightness values of pixels in each ROI as intensity distribution data. At this time, the acquisition units 201 and 201A may calculate an average value and a standard deviation of the sum of the brightness values and normalize the distribution between the ROIs so that the average value of the intensity distribution data is 0 and the standard deviation of the data is 1 or normalize the distribution between the ROIs with the maximum value.

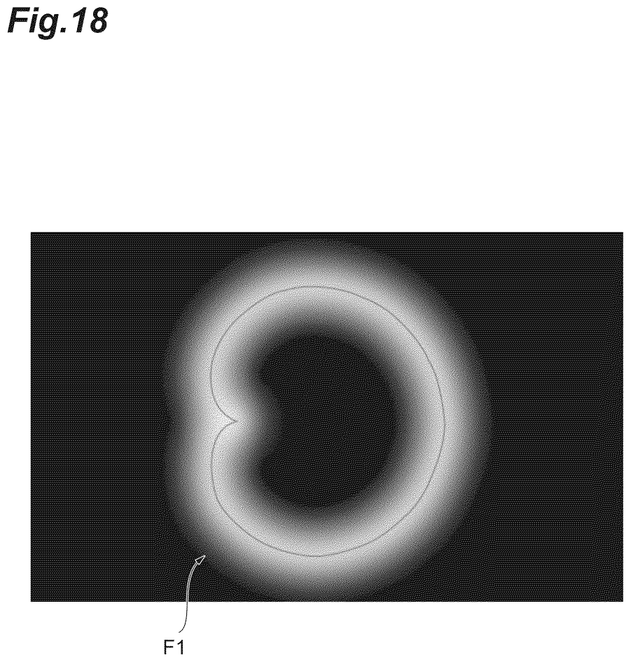

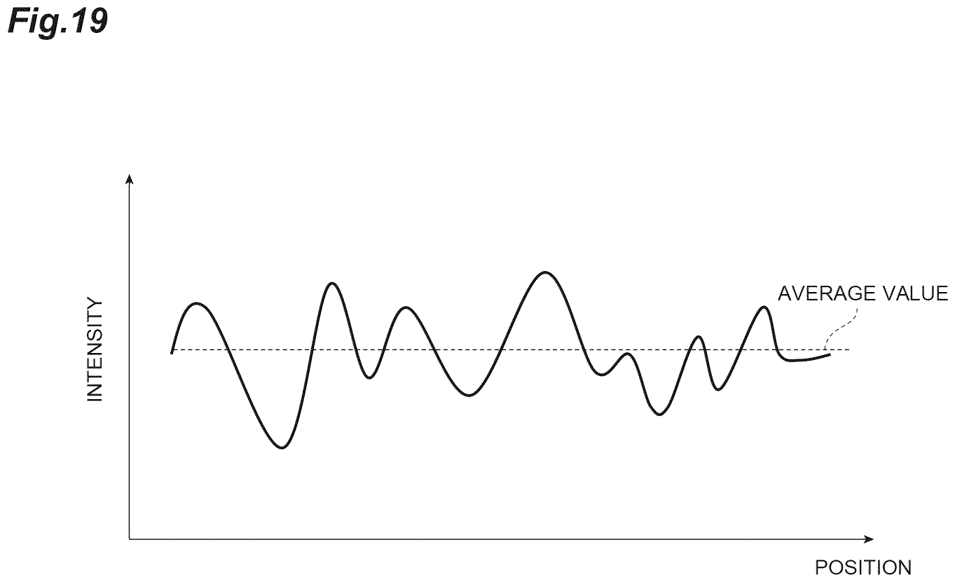

FIG. 18 is a diagram showing an example of an intensity image input from an imaging element, and FIG. 19 is a graph of intensity distribution represented by intensity distribution data acquired by the acquisition units 201 and 201A. Thus, by sequentially shifting the position of each ROI having a predetermined shape (for example, a linear shape perpendicular to the tangent of the curve) along a curve F1 (for example, a cardioid curve), which is defined by a function set in advance, on an intensity image by the acquisition units 201 and 201A, a plurality of ROIs are set. In addition, by processing the intensity image by the acquisition units 201 and 201A, intensity distribution data is obtained in which the intensity data for each position of the shifted ROI is arranged one-dimensionally.

Also in these modification examples, it is possible to shorten the calculation time during learning of the learning model 207 or prediction of the Zernike coefficients and realize highly accurate aberration correction.

In addition, in the optical system 1 according to each of the first to third embodiments described above, when building a learning model (during learning processing), a trained learning model that has already been built may be used to reduce the learning data and shorten the learning time. For example, when a predetermined amount of time has passed from the last building, it is assumed that the relationship between the Zernike coefficient and the light intensity distribution will be slightly different due to the occurrence of misalignment of the optical axis of the optical system, or the like. In this case, if a method called transfer learning is used, learning data obtained during observation of the sample can be re-learned. As a result, a learning model that is effective during observation can be rebuilt in a shorter learning time by using a smaller set of data. For example, when the effect of the parameter related to the optical axis of the optical system on the output result in the learning model 207 can be absorbed by tuning some layers of the neural network, the learning unit 203A re-learns only the weights of some layers without re-learning the weights of all the layers when building the learning model 207. According to such a modification example, since it is possible to speed up the convergence of errors in the output values of the learning model, it is possible to improve the efficiency of learning.

In any of the embodiments described above, it is preferable that the light correction coefficients are coefficients of the Zernike polynomial to give the shape of the wavefront of the light. In this case, highly accurate aberration correction can be realized by correction based on the light correction coefficient predicted by the learning model.

In any of the embodiments described above, it is also preferable to acquire the intensity distribution as a brightness distribution by calculating the sum of brightness values of pixels for each of a plurality of regions of interest. In this case, data that more accurately reflects the distribution of intensities in a plurality of regions of interest based on the intensity image can be input to the learning model that predicts the light correction coefficient. As a result, it is possible to realize more accurate aberration correction.

In addition, in any of the embodiments described above, it is preferable to acquire the intensity distribution as a distribution in a plurality of regions of interest set by sequential shifting along a direction set in advance on the intensity image. In this case, data that more accurately reflects the intensity distribution along a predetermined direction based on the intensity image can be input to the learning model that predicts the light correction coefficient. As a result, it is possible to realize more accurate aberration correction.

In addition, in any of the embodiments described above, it is also preferable to input parameters affecting aberrations related to light to the learning model in addition to the light correction coefficients and the comparison data. According to such a configuration, the parameters affecting aberrations related to light can be further input to the learning model that predicts the light correction coefficient. As a result, it is possible to realize more accurate aberration correction.

In addition, in any of the embodiments described above, it is also preferable to further predict adjustable parameters affecting aberrations related to light by using the learning model. In this case, the parameters affecting aberrations related to light are further predicted by the learning model that predicts the light correction coefficient. Then, by adjusting the optical system and the like based on the predicted parameters, it is possible to realize more accurate aberration correction.

### REFERENCE SIGNS LIST

1, 1A, 1B, 1C, 1D, 1E, 1F: optical system, 3: light source, 7: imaging element, 9: spatial light modulator, 11, 11A, 11B: control device, 201, 201A: acquisition unit, 202: generation unit, 203, 203A, 203B: learning unit, 205, 205B: control unit, 204, 204A, 204B: prediction unit, 207, 207B: learning model.

1: A light correction coefficient prediction method, comprising:
acquiring an intensity distribution that is a distribution of intensities in a plurality of regions of interest within a predetermined range on an intensity image, the intensity image being obtained by observing an action caused by light corrected using a light modulator based on a light correction coefficient;
calculating a comparison result between the intensity distribution and a target distribution to generate comparison data; and
predicting a light correction coefficient, which is for performing aberration correction related to the light so that the intensity distribution approaches the target distribution, by inputting the comparison data and the light correction coefficient, which is a basis of the intensity distribution, to a learning model.

2: The light correction coefficient prediction method according to claim 1,
wherein the light correction coefficient is a coefficient of a Zernike polynomial to give a wavefront shape of the light.

3: The light correction coefficient prediction method according to claim 1,
wherein the intensity distribution is acquired as a brightness distribution by calculating a sum of brightness values of pixels for each of the plurality of regions of interest.

4: The light correction coefficient prediction method according to claim 1,
wherein the intensity distribution is acquired as a distribution in the plurality of regions of interest set by sequential shifting along a direction set in advance on the intensity image.

5: The light correction coefficient prediction method according to claim 1,
wherein a parameter affecting aberrations related to the light is input to the learning model in addition to the light correction coefficient and the comparison data.

6: The light correction coefficient prediction method according to claim 1,
wherein an adjustable parameter affecting aberrations related to the light is further predicted by using the learning model.

7: A light correction coefficient prediction device, comprising a processor configured to:
acquire, for an intensity image obtained by observing an action caused by light corrected using a light modulator based on a light correction coefficient, an intensity distribution that is a distribution of intensities in a plurality of regions of interest within a predetermined range on the intensity image;
calculate a comparison result between the intensity distribution and a target distribution to generate comparison data; and
predict a light correction coefficient, which is for performing aberration correction related to the light so that the intensity distribution approaches the target distribution, by inputting the comparison data and the light correction coefficient, which is a basis of the intensity distribution, to a learning model.

8: The light correction coefficient prediction device according to claim 7,
wherein the light correction coefficient is a coefficient of a Zernike polynomial to give a wavefront shape of the light.

9: The light correction coefficient prediction device according to claim 7,
wherein the intensity distribution is acquired as a brightness distribution by calculating a sum of brightness values of pixels for each of the plurality of regions of interest.

10: The light correction coefficient prediction device according to claim 7,
wherein the intensity distribution is acquired as a distribution in the plurality of regions of interest set by sequential shifting along a direction set in advance on the intensity image.

11: The light correction coefficient prediction device according to claim 7,
wherein a parameter affecting aberrations related to the light is input to the learning model in addition to the light correction coefficient and the comparison data.

12: The light correction coefficient prediction device according to claim 7,
wherein an adjustable parameter affecting aberrations related to the light is further predicted by using the learning model.

13: A machine learning method, comprising:
acquiring an intensity distribution that is a distribution of intensities in a plurality of regions of interest within a predetermined range on an intensity image, the intensity image being obtained by observing an action caused by light corrected using a light modulator based on a light correction coefficient;
calculating a comparison result between the intensity distribution and a target distribution to generate comparison data; and
training a learning model to output a light correction coefficient, which is for performing aberration correction related to the light so that the intensity distribution approaches the target distribution, by inputting the comparison data and the light correction coefficient, which is a basis of the intensity distribution, to the learning model.

14: A pre-processing method in machine learning for generating data to be input to the learning model used in the machine learning method according to claim 13, comprising:
acquiring an intensity distribution that is a distribution of intensities in a plurality of regions of interest within a predetermined range on an intensity image, the intensity image being obtained by observing an action caused by light corrected using a light modulator based on a light correction coefficient;
calculating a comparison result between the intensity distribution and a target distribution to generate comparison data; and
concatenating the comparison data and the light correction coefficient, which is a basis of the intensity distribution.

15: A trained learning model built by training using the machine learning method according to claim 13.
